(19) United States
(12) Patent Application Publication
(10) Pub. No.: US 2016/0186704 A1
(43) Pub. Date: Jun. 30, 2016

(54) EXHAUST GAS RECIRCULATION SYSTEM FOR ENGINE

(71) Applicant: MAZDA MOTOR CORPORATION, Hiroshima (JP)

(72) Inventors: Mitsuyuki MUROTANI, Hiroshima-shi (JP); Yasushi NAKAHARA, Higashihiroshima-shi (JP); Hiroshi SUMIMOTO, Aki-gun (JP); Junji UMEMURA, Aki-gun (JP)

(73) Assignee: MAZDA MOTOR CORPORATION, Hiroshima (JP)

(21) Appl. No.: 14/959,347

(22) Filed: Dec. 4, 2015

(30) Foreign Application Priority Data
Dec. 26, 2014 (JP) 2014-265912

(51) Int. Cl. F02M 35/10; F02M 25/07

(52) U.S. Cl. CPC F02M 35/10222; F02M 25/0703; F02M 25/0737; F02M 35/10321

(57) ABSTRACT

Disclosed is an exhaust gas recirculation system provided in an engine to recirculate, to an intake manifold, a part of exhaust gas discharged from an engine body, as EGR gas. The exhaust gas recirculation system comprises: an in-head gas passage formed in a cylinder head to allow the EGR gas to pass through a position adjacent to a first coolant jacket formed in the cylinder head to allow coolant to flow therethrough an EGR cooler configured to cool the EGR gas after passing through the cylinder head via the in-head gas passage and before being introduced into the intake manifold; and a relay pipe configured to guide the EGR gas just after passing through the cylinder head, to the EGR cooler. The relay pipe is provided with a second coolant jacket for allowing coolant to flow therethrough so as to cool the EGR gas being flowing inside the relay pipe.

### BACKGROUND OF THE INVENTION

1. Field of the Invention

The present invention relates to an exhaust gas recirculation system for recirculating a part of exhaust gas to an intake system of an engine.

2. Background Art

Heretofore, it has been common practice to recirculate a part of exhaust gas to an intake system of an engine to thereby lower a combustion temperature and thus suppress the occurrence of NOx.

In this case, if exhaust gas recirculated to the intake system (EGR gas) has a high temperature, it becomes a factor of deterioration in charging efficiency of intake, air. Therefore, there has been employed a technique of mounting an EGR cooler using engine cooling water as a cooling medium, to an engine, to recirculate EGR gas after being cooled by the EGR, to an intake system. There has also been employed a technique of forming an EGR gas recirculation passage inside a cylinder head to cool EGR gas by engine cooling water being circulated inside the cylinder head, as disclosed in JP 2013-174171A.

However, for example, in a turbocharged engine, there are some cases where an exhaust gas temperature in a high-speed and high-load operation region rises to a high temperature of around 1000° C. Thus, if, in this operation region, EGR gas is directly introduced into the EGR cooler, the EGR cooler undergoes large thermal expansion, thereby possibly causing degradation due thermal fatigue. While an EGR cooler necessary to avoid such a problem to ensure reliability thereof is a type increased in size and highly improved in heat resistance, this type leads to not only an increase in cost of an EGR system (exhaust gas recirculation system) but also deterioration in mountability to the engine.

Although it is conceivable to combinationally use the technique disclosed in the JP 2013-174171A, it is difficult to sufficiently cool EGR gas because the technique has limits in terms of gas cooling capacity.

### SUMMARY OF THE INVENTION

In view of the above circumstances, it is an object of the present invention to provide an exhaust gas recirculation system capable of cooling high-temperature EGR gas in a better manner without deterioration in mountability of an EGR cooler to an engine and significant increase in cost.

In order to achieve the object, the present invention provides an exhaust gas recirculation system provided in an engine to recirculate, to an intake manifold, a part of exhaust gas discharged from an engine body, as EGR gas. The exhaust gas recirculation system comprises: an in-head gas passage formed in a cylinder head to allow the EGR gas to pass through a position adjacent to a first coolant jacket formed in the cylinder head to allow coolant to flow therethrough; an EGR cooler configured to cool the EGR gas after passing through the cylinder head via the in-head gas passage and before being introduced into the intake manifold; and a relay pipe configured to guide the EGR gas just after passing through the cylinder head, to the EGR cooler, wherein the relay pipe is provided with a second coolant jacket for allowing coolant to flow therethrough so as to cool the EGR gas being flowing inside the relay pipe.

### BRIEF DESCRIPTION OF THE DRAWINGS

FIG. 1 is a sectional view illustrating an overall structure of an engine equipped with an exhaust gas recirculation system according to the present invention.

FIG. 2 is a perspective view illustrating the exhaust gas recirculation system (when viewed from an intake side of the engine).

FIG. 3 is a perspective view illustrating the exhaust gas recirculation system (when viewed from an exhaust side of the engine).

FIG. 4 is a sectional view (taken along the line IV-IV in FIG. 1) illustrating an in-head gas passage constituting an EGR passage.

FIG. 5 is a sectional view (taken along the line V-V in FIG. 1) illustrating the in-head gas passage constituting the EGR passage.

FIG. 6 is a sectional view (taken along the line VI-VI in FIG. 1) illustrating the in-head gas passage constituting the EGR passage.

FIG. 7 is a top plan view illustrating a relay pipe constituting the EGR passage.

FIG. 8 is sectional view illustrating an intake manifold.

### DETAILED DESCRIPTION OF THE PREFERRED EMBODIMENTS OF THE INVENTION

With reference to the accompanying drawings, the present invention will now be described in detail, based on one preferred embodiment thereof.

### <Overall Configuration>

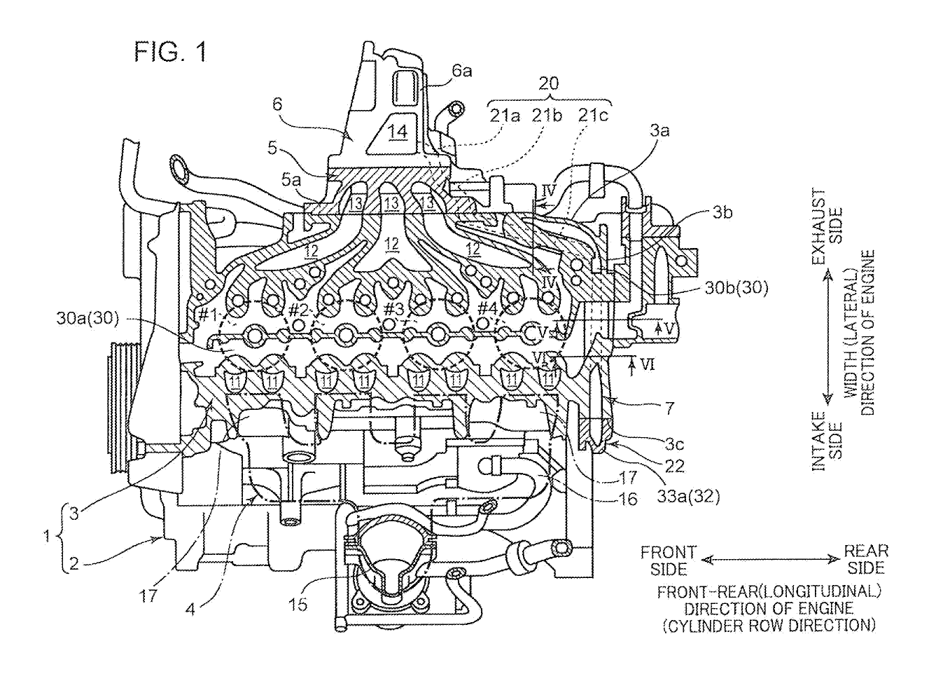

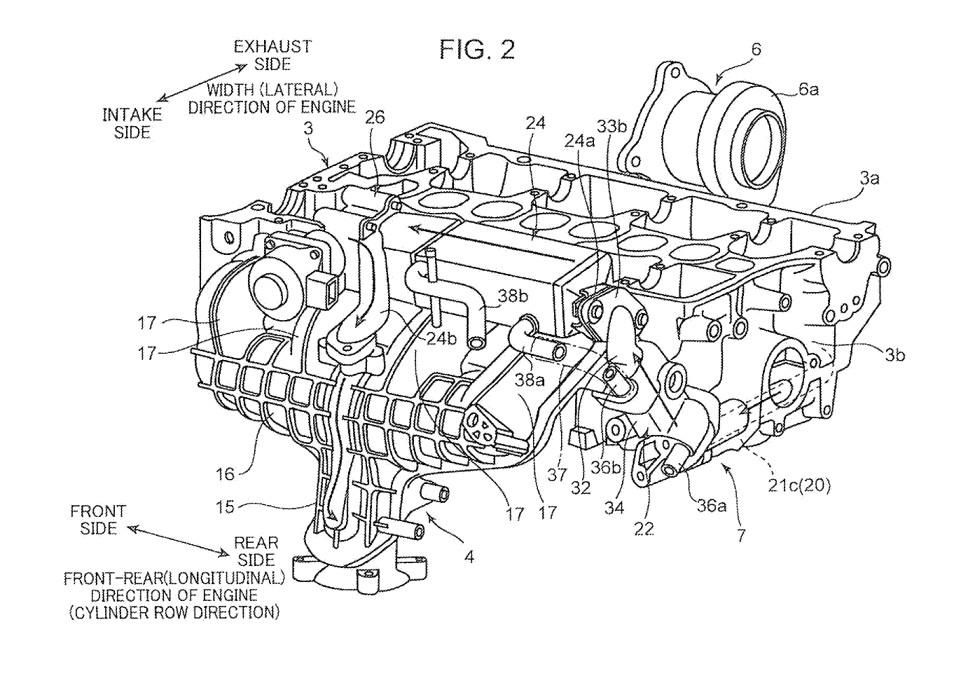

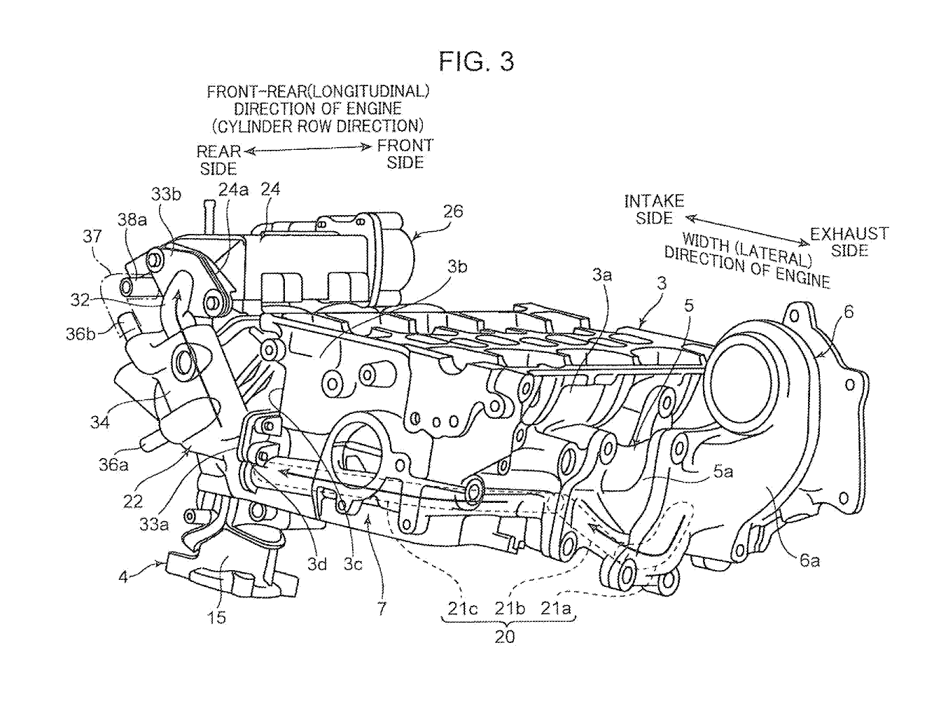

FIG. 1 is a sectional view illustrating an overall structure of an engine equipped with an exhaust gas recirculation system according to one embodiment of the present invention, and FIGS. 2 and 3 are perspective views mainly illustrating a portion of the engine corresponding to the exhaust gas recirculation system.

An engine illustrated in FIG. 1 is an engine for a vehicle such as an automotive vehicle, more specifically a multi-cylinder gasoline engine equipped with a supercharger. This engine comprises: an in-line four-cylinder engine body 1 having a first (#1) cylinder to a fourth (#4) cylinder; an intake system comprising an intake manifold 4; an exhaust system comprising a exhaust-gas valve unit 5; a turbocharger (turbosupercharger) 6 as the above supercharger; and an exhaust gas recirculation system 7 for recirculating a part of exhaust gas to an intake manifold.

In the following description, an arrangement direction of the first (#1) to fourth (#4) cylinders (cylinder row direction) will be referred to as “front-rear (longitudinal) direction of the engine”, and a side close to the first (#1) cylinder and a side close to the fourth (#4) cylinder will be referred to respectively as “front side of the engine” and “rear side of the engine”. Unless otherwise noted, a direction of each portion of the exhaust gas recirculation system will also be described based on the above directions. Further, a direction perpendicular to the arrangement direction of the first (#1) to fourth (#4) cylinders will be referred to as “width (lateral) direction of the engine”.

The engine body 1 comprises an oil pan (not illustrated), a crankcase (not illustrated), a cylinder block 2, a cylinder head 3 and a cylinder head cover (not illustrated), which are stacked up in this order and integrally connected together.

The cylinder block 2 is formed with four cylinder bores making up the first (#1) to fourth (#4) cylinders, and the cylinder head 3 is formed with four sets of an intake port 11 and an exhaust port (not illustrated) communicated with the respective cylinder bores on a per-set basis,

As illustrated in FIGS. 1 and 2, the intake manifold 4 is fixed to an intake-side lateral surface 3c of the cylinder head 3. The intake manifold 4 has, in order from an upstream side in an intake air flow direction, a collector portion 15 into which intake an flows, a surge tank portion 16 communicating with the collector portion 15 and extending in the longitudinal direction of the engine, and four branch portions 17 branched from the surge tank portion 16 to introduce intake air into corresponding ones of the intake ports 11 of the #1 to #4 cylinders. The intake manifold 4 is entirely formed of a synthetic resin material.

On an upstream side of the collector portion 15 of the intake manifold 4, a plurality of components including a throttle body equipped with a throttle valve for changing a flow passage area of intake air and an air cleaner for purifying intake air (not illustrated) are connected in this order. That is in this engine, an intake passage for introducing intake air into the #1 to #4 cylinders therethrough is formed, for example, by the intake manifold 4, the throttle body, the air cleaner, and non-illustrated ducts fluidically connecting them together.

The cylinder head 3 is also formed with a plurality of independent passages 12 for discharging exhaust gas generated in the #1 to #4 cylinders. In this embodiment, the cylinder head 3 is formed with total three independent passages 12: an independent passage 12 communicating with the exhaust port of the first (#1) cylinder; an independent passage 12 communicating with the exhaust ports of the second (#2) and third (#3) cylinders; and an independent passage 12 communicating with the exhaust port of the fourth (#4) cylinder. The independent passages 12 are formed such that respective downstream ends thereof in an exhaust gas flow direction are gathered in a longitudinally central region of the cylinder head 3, and opened to an exhaust-side lateral surface 3a of the cylinder head 3 individually.

The exhaust-gas valve unit 5 is fixed to the exhaust-side lateral surface 3a of the cylinder head 3. The exhaust-gas valve unit 5 is designed to change a flow passage area of exhaust gas discharged from the engine body 1 via the independent passages 12 to thereby change a flow velocity of exhaust gas to be introduced into the turbocharger 6.

The exhaust-gas valve unit 5 comprises: a unit body 5a having three independent passages 13 communicating with the respective independent passages 12 of the cylinder head 3, and an in-unit gas passage 21b as a part of an aftermentioned EGR passage; and an exhaust variable valve (not illustrated) configured to be driven by a non-illustrated motor. The exhaust variable valve is operable to change flow passage areas of the independent passages 13. The unit body 5a is composed, for example, of a metal cast body of heat-resistant cast steel or the like.

The turbocharger 6 is fixed to a lateral surface of the exhaust-gas valve unit 5 (unit body 5a). The turbocharger 6 comprises a turbine housing 6a fixed to the exhaust-gas valve unit 5, a non-illustrated turbine disposed inside the turbine housing 6a, a non-illustrated compressor housing interposed in the intake passage, a non-illustrated compressor disposed inside the compressor housing, and a non-illustrated coupling shaft coupling the turbine and the compressor together. During operation of the engine, the turbine is rotated in response to receiving energy of exhaust gas discharged from the engine body 1, the compressor coupled to the turbine is driven at the same rotational speed as that of the turbine, so that intake air is compressed and sent to the #1 to #4 cylinders of the engine body 1. Each of the turbine and compressor housings of the turbocharger 6 is composed, for example, of a metal east body of heat-resistant cast steel or the like.

The turbine housing 6a has a collector section 14 composed of a single space with which the independent passages 13 of the exhaust-gas valve unit 5 communicate. Exhaust gas discharged from the engine body 1 is merged in the collector section 14 via the independent passages 12, 23, and then sent to the turbine.

A plurality of components including a non-illustrated catalytic device and a non-illustrated silencer are connected to the turbine housing 6a of the turbocharger 6 in this order. That is, in this engine, an exhaust passage for discharging exhaust gas generated in the engine body 1 therethrough is formed, for example, by the exhaust-gas valve unit 5, the turbocharger 6 (turbine housing 6a), the catalytic device, the silencer, and non-illustrated ducts fluidically connecting them together. Further, in this engine, a so-called exhaust manifold is formed of a combination of the independent passages 12, 13 of the cylinder head 3 and the exhaust-gas valve unit 5, and the collector section 14 of the turbocharger 6.

The exhaust gas recirculation system 7 is designed to return a part of exhaust gas, from the exhaust system (exhaust passage) to the intake system (intake passage), i.e., perform so-called exhaust gas recirculation (EGR). Specifically, the exhaust gas recirculation system 7 is configured to extract exhaust gas from the collector section 14 of the turbocharger 6 and recirculate, as recirculation gas (hereinafter referred to as “EGR gas”), the extracted exhaust gas to the collector portion 15 of the intake manifold 4.

As illustrated in FIGS. 1 to 3, the exhaust gas recirculation system 7 comprises: an EGR passage 20 formed in the cylinder head 3 and others; an EGR cooler 24 configured to cool EGR gas after passing through the cylinder head 3 and others and before being introduced into the intake manifold 4; a relay pipe 22 configured to guide EGR gas just after passing through the cylinder head 3, to the EGR cooler 24; and an EGR valve 26 configured to adjust a flow rate of EGR gas (EGR amount).

The EGR passage 20 comprises: an in-supercharger gas passage 21 a formed in the turbine housing 6a of the turbocharger 6; an in-unit gas passage 21b formed in the unit body 5a of the exhaust-gas valve unit 5; and an in-head gas passage 21c formed in the cylinder head 3. The in-supercharger gas passage 21a and the in-unit gas passage 21b communicate with each other at a position of a joint surface between the turbocharger 6 and the exhaust-gas valve unit 5, and the in-unit gas passage 21b and the in-head gas passage 21c communicate with each other at a position of a joint surface between the exhaust-gas valve unit 5 and the cylinder head 3.

As illustrated in FIG. 1, the in-unit gas passage 21b is formed in the unit body 5a at a position on the side of a rearmost one of the three independent passages 13 to extend parallel to the rearmost independent passage 13. The in-head gas passage 21c is formed in the cylinder head 3 to extend rearwardly from a position of the joint surface with the exhaust-gas valve unit 5, along the exhaust-side lateral surface 3a of the cylinder head 3, and bend toward the intake side at a position, of a rear end of the cylinder head 3, whereafter the in-head gas passage 21c extends toward the intake side along a rear surface 3b of the cylinder head 3, and finally open in the intake-side lateral surface 3c of the cylinder head 3. The in-head gas passage 21c is provided at a position adjacent to a bottom of the cylinder head 3 to extend along the bottom over the overall length of the in-head gas passage 21c.

Based on the above configuration, the EGR passage 20 can guide EGR gas from the collector section 14 of the turbocharger 6 to a position in a rear end region of the intake-side lateral surface 3c of the cylinder head 3, via respective insides of the turbine housing 6a of the turbocharger 6, the unit body 5a of the exhaust-gas valve unit 5, and the cylinder head 3. Thus, a non-illustrated gas outlet of the EGR passage 20 (the in-head gas passage 21c) is formed in the rear end region of the intake-side lateral surface 3c.

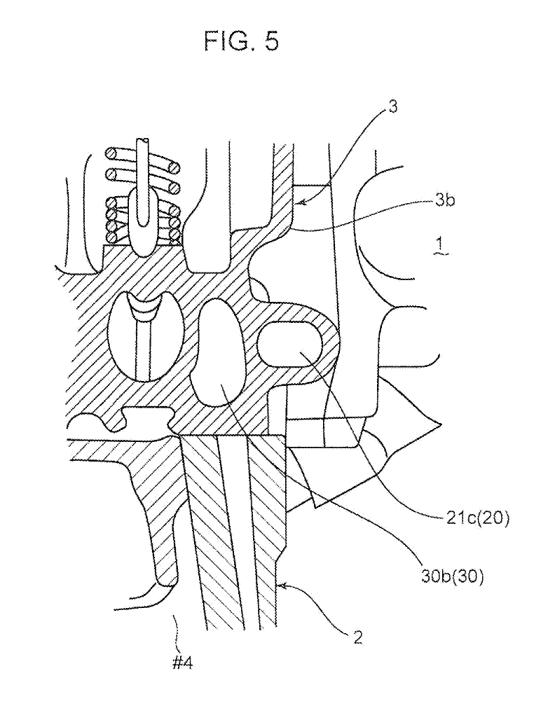

The cylinder head 3 is internally formed with a water jacket 30 (equivalent to “first coolant jacket” set forth in the appended claims) for circulating engine cooling water (hereinafter referred to simply as “cooling water”; one example of “coolant” set forth in the appended claims). As illustrated in FIGS. 1 and 4 to 6, this water jacket 30 comprises a main jacket 30a for allowing the cooling water to flow in the longitudinal direction, mainly, around combustion chambers and a branch jacket 30b branched from the main jacket 30a to allow the cooling water to flow along the in-head gas passage 21c (EGR passage 20). The main jacket 30a is provided mainly for the purpose of cooling the cylinder head 3, and the branch jacket 30b is provided mainly for the purpose of cooling EGR gas flowing through the in-head gas passage 21c.

In this embodiment, the branch jacket 30b is formed along approximately the entire region of the in-head gas passage 21c, and a part of the branch jacket 30b is formed to surrounding the in-head gas passage 21c in an angular range of at least 90 degrees or more in a cross-section thereof. Specifically, the branch jacket 30b is configured such that the angle θ defined by line segments connecting both ends of the branch jacket 30b and the center axis O is 90° or larger in a section perpendicularly intersecting the center axis O of the in-head gas passage 21c. By forming the branch jacket 30b along the in-head gas passage 21c in this way, EGR gas flowing through the in-head gas passage 21c can be effectively cooled.

The EGR cooler 24 is mounted on an upper portion of the intake manifold 4. Specifically, the EGR cooler 24 is supported on the branch portions 17 of the intake manifold 4, and an attachment flange formed on the EGR cooler 24 is fixed on the branch portions 17 by a bolt and a nut.

The EGR cooler 24 has an approximately rectangular parallelepiped shape extending in the longitudinal direction along the intake-side lateral surface 3c of the cylinder head 3. Then, the relay pipe 22 is fixed to each of a rear end of the EGR cooler 24 and the intake-side lateral surface 3c of the cylinder head 3 to extend therebetween, so that the EGR passage 20 communicates with the EGR cooler 24 via the gas outlet formed in the intake-side lateral surface 3c of the cylinder head 3, an internal passage of the relay pipe 22, and a non-illustrated gas inlet formed on the rear end of the EGR cooler 24. In the state in which the EGR cooler 24 is fixed to the upper portion of the intake manifold 4, the gas inlet of the EGR cooler 24 is located offset upwardly with respect to the gas outlet of the EGR passage 20 (in-head gas passage 21c). Thus, the relay pipe 22 is disposed to extend in an up-down direction to fluidically connect the gas inlet and the gas outlet together, as illustrated in FIGS. 2 and 3.

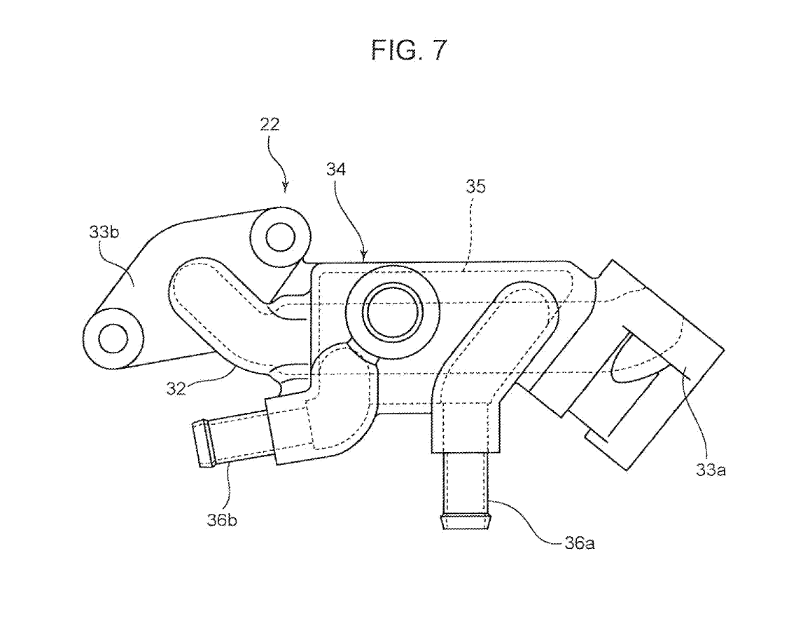

As illustrated in FIG. 7, the relay pipe 22 has a structure comprising a pipe body 32 made of a metal material and provided with two attachment flanges 33a, 33b at respective opposite ends, and a cooling housing 34 made of a metal material and provided between the attachment flanges 33a. 33b to surround the pipe body 32, wherein the pipe body 32 and the cooling housing 34 are integrally joined together by welding or the like.

One of the attachment flanges 33a, 33b located on an upstream side in an EGR gas flow direction, i.e., the attachment flange 33a, is fixed to a mounting flange 3d (FIG. 3) formed on the intake-side lateral surface 3c of the cylinder head 3 by a bolt and a nut, and the other downstream-side attachment flange 33b is fixed to a mounting flange 24a (FIGS. 2 and 3) formed around the gas inlet of the EGR cooler 24 by a bolt and a nut.

The cooling housing 34 comprises a water jacket 35 (equivalent to “second coolant jacket” set forth in the appended claims) surrounding the pipe body 32 entirely therearound, and further comprises a tubular-shaped inlet port portion 36a and a tubular-shaped outlet port portion 36b for introducing and discharging therethrough cooling water (one example of “coolant” set forth in the appended claims) with respect to the water jacket 35. A non-illustrated duct such as a heat-resistant pipe is connected to the inlet port portion 36a, so that cooling water sent from an ATF warmer (not illustrated) for heating up oil for an automatic transmission is introduced into the water jacket 35 via the duct and the inlet port portion 36a. On the other hand, the outlet port portion 36b is connected to an aftermentioned inlet port portion 38a of the EGR cooler 24 via a duct 37 such as a heat-resistant pipe, to allow cooling water after passing through the water jacket 35 of the relay pipe 22, to be introduced into the EGR cooler 24.

The EGR valve 26 is coupled and fixed to (FIGS. 2, 3 and 8) a front end of the EGR cooler 24, i.e., supported by the intake manifold 4 (branch portions 17) through the EGR cooler 24.

The front end of the EGR cooler 24 is formed with a non-illustrated gas outlet for discharging EGR gas from the EGR cooler 24 to the EGR valve 26 therethrough, and a has re-inlet for re-introducing EGR gas just after being subjected to flow rate adjustment by the EGR valve 26, from the EGR valve 26 into the EGR cooler 24 therethrough. Further, a guide pipe 24b is integrally attached to a lateral surface of a front portion of the EGR cooler 24 by welding or the like, in such a manner as to guide EGR gas re-introduced into the EGR cooler 24, directly into the intake manifold 4 therethrough. That is, EGR gas after passing through the EGR cooler 24 is introduced into the EGR valve 26, and then returned from the EGR valve 26 to the EGR cooler 24, whereafter the returned EGR gas is sent to the intake manifold 4 via the guide pipe 24b.

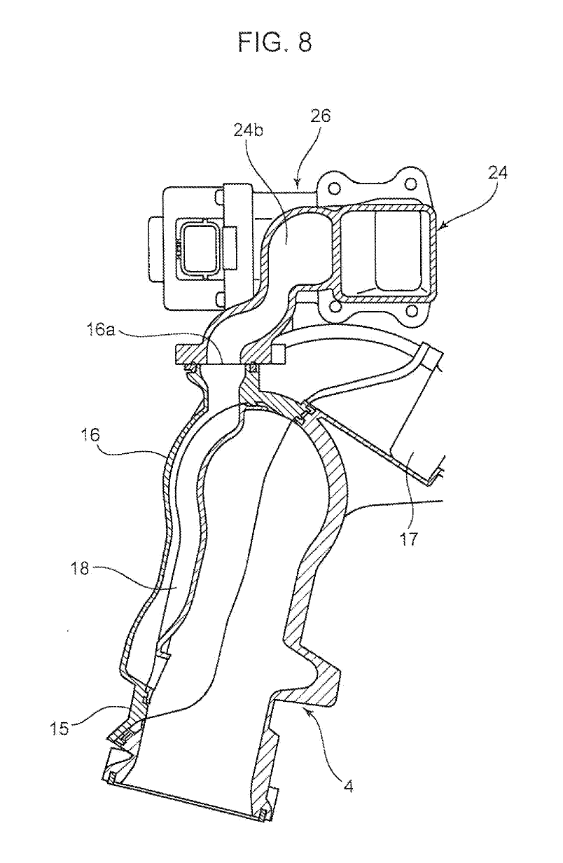

As illustrated in FIG. 8, an upper portion of the surge tank portion 16 of the intake manifold 4 is formed with a gas inlet 16a in a longitudinally central region thereof. In addition to the intake passage, the intake manifold 4 is internally formed with a hollow gas guide passage 18 extending in an up-down direction along an inner wall surface of the intake manifold 4 to communicate the gas inlet 16a and an internal space of the collector portion 15. Thus, EGR gas introduced from the gas inlet 16a into the intake manifold 4 is merged with intake air at a position on an upstream side of the collector portion 15, i.e., at a position adjacent to an upstream-side end of the collector portion 15 in the intake air flow direction.

As illustrated in FIG. 2, the EGR cooler 24 has: an inlet port portion 38a provided at a position adjacent to a rear edge of the lateral surface thereof to introduce coolant water into the EGR cooler 24 therethrough; and an outlet port portion 38b provided at a position adjacent to a front edge of the lateral surface thereof to discharge coolant water from the EGR cooler 24 therethrough. As mentioned above, the inlet port portion 38a is connected to the outlet port portion 36b of the relay pipe 22 via the duct 37. On the other hand, a non-illustrated duct such as a heat-resistant pipe is connected to the outlet port portion 38b, so that cooling water after passing through the EGR cooler 24 is sent to a non-illustrated water pump via this duct.

### <Functions/Effect of Exhaust Gas Recirculation System 7>

In the above engine, a part of exhaust gas discharged from the engine body 1 is extracted from the collector section 14 of the turbine housing 6a to the EGR passage 20, and sent to the EGR cooler 24 via the EGR passage 20 and the relay pipe 22, as indicated by arrowed lines in FIGS. 2 and 3. Then, the EGR gas is introduced from the EGR valve 26 to the intake manifold 4 via the guide pipe 24b, and guided into the collector portion 15 of the intake manifold 4 via the gas guide passage 18.

In this EGR gas flow process EGR gas extracted from the collector section 14 of the turbine housing 6a is firstly cooled by cooling water in the branch jacket 30b during passing through the EGR passage 20 in the cylinder head 3 (in-head gas passage 21c), and secondly cooled by cooling water in the water jacket 35 of the relay pipe 22 during passing through the relay pipe 22, whereafter the EGR gas is introduced into and cooled by the EGR cooler 24. Thus, as compared to the case where EGR gas discharged from the engine body is introduced into the intake manifold directly via only the EGR cooler, i.e., the EGR gas is cooled by only the EGR cooler and then introduced into the intake manifold, it becomes possible to effectively cool EGR gas. In addition, before introduction into the EGR cooler 24, EGR gas can be sufficiently cooled by the cylinder head 3 and the relay pipe 22, so that it is possible to significantly reduce a burden of EGR gas cooling on the EGR cooler 24. This makes it possible to sufficiently cool high-temperature EGR gas without employing a large size and highly heat-resistant EGR cooler. Thus, in the exhaust gas recirculation system 7, as the EGR cooler 24, a relatively small and low-cost EGR cooler can be employed. This provides an advantage of being able to adequately cool high-temperature EGR gas without causing deterioration in accountability of the EGR cooler 24 to the engine and increase in cost.

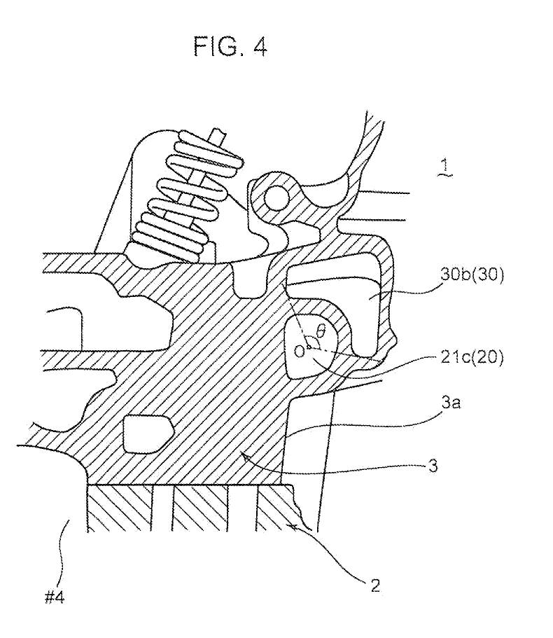

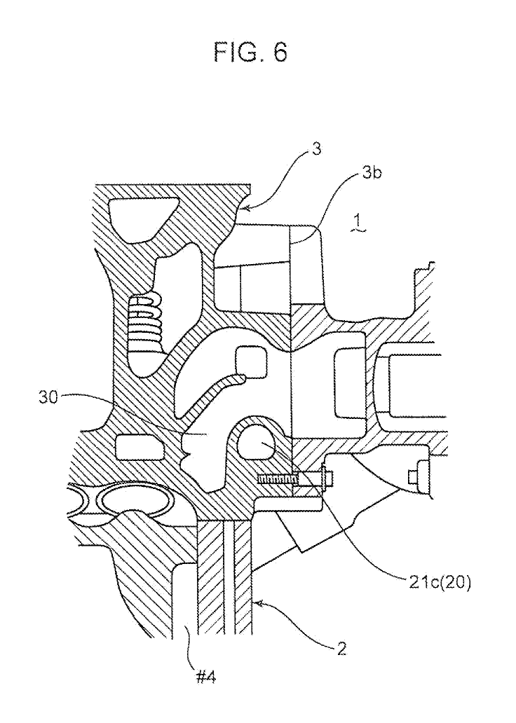

Particularly, in the exhaust gas recirculation system 7, as a part of the water jacket 30, the branch jacket 30b is formed in the cylinder head 3 to extend the in-head gas passage 21c, wherein a part of the branch jacket 30b is formed to surround the in-head gas passage 21c in an angular range of at least 90 degrees or more in a cross-section thereof (FIGS. 4 and 6). Further, the water jacket 35 of the relay pipe 22 is formed to surround the pipe body 32 entirely therearound. This makes it possible to effectively cool EGR gas during a course from the turbine housing 6a through until the EGR gas reaches the EGR cooler 24. For example, the above engine is designed on an assumption that EGR gas is recirculated to the intake side in a high-speed and high-load operation region, wherein, in the high-speed and high-load operation region, a temperature of exhaust gas discharged from the engine body 1 reaches a high temperature of about 900 to 1000° C. However, it has been experimentally ascertained that the above exhaust gas recirculation system 7 configured as above can reduce a temperature of EGR gas to an average exhaust gas temperature (about 700° C.) before the EGR gas is introduced into the EGR cooler 24.

In the above exhaust gas recirculation system 7, the cylinder head 3 and the EGR cooler 24 are connected together directly via the relay pipe 22 having the cooling housing 34. Thus, there is an advantage of being able to suppress heat damage to surroundings due to heat of EGR gas, in a position between the cylinder head 3 and the EGR cooler 24. Specifically, a component such as a fuel delivery pipe or a wire harness of a valve operation device can be disposed around the relay pipe 22. Even in this situation, the relay pipe 22 having the cooling housing 34 has an advantage of being able to prevent the fuel delivery pipe, the wire harness or the like from receiving high radiation heat from the relay pipe 22.

In the above exhaust gas recirculation system 7 under recirculation of high-temperature (about 1000° C.) EGR gas, the cooling burden on the EGR cooler 24 can be reduced. Thus, a relatively small and lightweight type, can be employed as the EGR cooler 24, as mentioned above, and therefore installed on the upper portion of the intake manifold 4 (branch portions 17). By this layout configuration in which the EGR cooler 24 is installed on the upper portion of the intake manifold 4, it is possible to eliminate a need to provide an installation space of the EGR cooler 24, separately. In addition, the EGR cooler 24 has a shape extending in the longitudinal direction of the engine body 1 (cylinder row direction), as mentioned above, so that it is laid out along the cylinder head 3 in a compact manner. Thus, the above exhaust gas recirculation system 7 has an advantage of being able to contribute to a reduction in size of the engine based on a compact engine configuration in which the EGR cooler 24 is installed on the upper portion of the intake manifold 4.

In the above exhaust gas recirculation system 7, EGR gas can be sufficiently cooled before being introduced into the EGR cooler 24, as mentioned above, so that it is possible to suppress an excessive temperature rise of the EGR cooler. Thus, even in the layout where the EGR cooler 24 is installed on the upper portion of the intake manifold 4, the intake manifold 4 can be formed of a synthetic resin material as mentioned above. This provides an advantage of be able to achieve a reduction in weight and cost of the intake manifold and thus a reduction in weight and cost of the engine.

In the above exhaust gas recirculation system 7, EGR gas is introduced into intake air at a position of the collector portion 15 of the intake manifold 4 (i.e., a longitudinally central portion of the intake manifold 4), via the guide pipe 24b connected to the EGR cooler 24, and the gas guide passage 18. This allows EGR gas introduced into the intake manifold 4 to be introduced into the #1 to #4 cylinders via the branch portions 17 while adequately dispersing the EGR gas over intake air. Thus, there is also an advantage of being able to enhance EGR gas distribution performance with respect to the #1 to #4 cylinders.

It should be noted that the above engine is one example of an engine employing the exhaust gas recirculation system according to one preferred embodiment of the present invention, and specific configurations of the exhaust gas recirculation system and the engine may be appropriately modified without departing from the spirit and scope of the present invention as set forth in appended claims.

For example, in the above embodiment, the exhaust gas recirculation system is applied to an in-line four-cylinder gasoline engine. Alternatively, the exhaust gas recirculation system may be applied to any suitable type of in-line multi-cylinder engine.

Further, although the water jacket 35 of the relay pipe 22 is formed to surround the pipe body 32 entirely therearound, the present invention is not limited thereto. For example, the water jacket 35 may be formed to surround a part of the pipe body 32 in the cross-section thereof, or may be formed to simply extend along the pipe body 32 without surrounding the pipe body 32.

Further, although the cylinder head 3 is formed with the branch jacket 30b extending along the in-head gas passage 21c (the EGR passage 20) to serve as a part of the water jacket 30, specific routes and shapes of the water jacket 30 (branch jacket 30b) and the in-head gas passage 21e are not limited thereto. The specific routes and shapes of the water jacket 30 (branch jacket 30b) and the in-head gas passage 21c may be appropriately selected to allow EGR gas passing through the cylinder head 3 to be adequately cooled by cooling water.

In the above embodiment, EGR gas after cooling is introduced into the collector portion 15 of the intake manifold 4 via the guide pipe 24b connected to the EGR cooler 24 and the gas guide passage 18 formed inside the intake manifold 4, i.e., a combination of the guide pipe 24b and the gas guide passage 18 makes up “guide passage section” set forth in the appended claims. Alternatively, the guide passage section may be composed of a single pipe member configured to introduce EGR gas from the EGR valve 26 directly to the collector portion 15.

The present invention will be outlined as follows.

The present invention provides an exhaust gas recirculation system provided in an engine to recirculate, to an intake manifold, a part of exhaust gas discharged from an engine body, as EGR gas. The exhaust gas recirculation system comprises: an in-head gas passage formed in a cylinder head to allow the EGR gas to pass through a position adjacent to a first coolant jacket formed in the cylinder head to allow coolant to flow therethrough;

an EGR cooler configured to cool the EGR gas after passing through the cylinder head via the in-head gas passage and before being introduced into the intake manifold; and a relay pipe configured to guide the EGR gas just after passing through the cylinder head, to the EGR cooler, wherein the relay pipe is provided with a second coolant jacket for allowing coolant to flow therethrough so as to cool the EGR gas being flowing inside the relay pipe.

In the exhaust gas recirculation system of the present invention, EGR gas is introduced into the intake manifold after it is cooled by the cylinder head (in-head gas passage), the relay pipe and the EGR cooler. Thus, as compared to the case where EGR gas discharged from the engine body is introduced into the intake manifold directly via only the EGR cooler, i.e., the EGR gas is cooled by only the EGR cooler and then introduced into the intake manifold, it becomes possible to effectively cool EGR gas. Particularly, before introduction into the EGR cooler, EGR gas can be sufficiently cooled by the cylinder head and the relay pipe, so that it becomes possible to cool high-temperature EGR gas without employing a large size and highly heat-resistant EGR cooler. This makes it possible to adequately cool high-temperature EGR gas without impairing mountability of the EGR cooler to the engine due to an increase in size of the EGR cooler, and causing a significant increase in cost due to an increase in size and an enhancement in heat resistance.

Preferably, in the exhaust gas recirculation system of the present invention, the relay pipe is connected directly to each of the cylinder head and the EGR cooler.

According to this feature, EGR gas is continuously cooled during a course from the cylinder head to the EGR cooler. Thus, it becomes possible to effectively cool EGR gas. It also becomes possible to suppress heat damage to surrounding devices due to heat of EGR gas, in a position between the cylinder head and the EGR cooler.

Preferably, in the exhaust gas recirculation system of the present invention, the first coolant jacket of the cylinder head has a portion surrounding the in-head gas passage in an angular range of at least 90 degrees or more in a cross-section thereof.

This feature makes it possible to more effectively cool EGR gas in the cylinder head (in-head gas passage).

Preferably, in the exhaust gas recirculation system of the present invention, the relay pipe has a pipe body for allowing the EGR gas to flow therethrough, wherein the second coolant jacket of the relay pipe surrounds the pipe body entirely therearound.

This feature makes it possible to more effectively cool EGR gas flowing through the relay pipe.

In the exhaust gas recirculation system having one or more the above features, EGR gas is cooled by the relay pipe, and a burden of EGR gas cooling on the EGR cooler can be reduced accordingly. Thus, it becomes possible to reduce size and weight of the EGR cooler. Thus, in the exhaust gas recirculation system having one or more the above features, the EGR cooler can be fixed to an upper portion of the intake manifold. In this case, it is preferable that a gas inlet of the EGR cooler is located offset upwardly with respect to a gas outlet of the in-head gas passage, wherein the relay pipe is disposed to extend in an up-down direction to fluidically connect the gas outlet to the gas inlet.

According to this feature, it becomes possible to obtain a compact layout configuration in which the EGR cooler is installed on the upper portion of the intake manifold. This contributes to a reduction in size of the engine.

Preferably, in the above exhaust gas recirculation system, the EGR cooler has a shape extending in a cylinder row direction of the engine body, wherein the exhaust gas recirculation system further comprises a guide passage section for introducing the EGR gas after being cooled by the EGR cooler, to the intake manifold at a position of a central portion thereof in the cylinder row direction.

According to this feature, the EGR cooler can be laid out along the cylinder head in a compact manner. In addition, EGR gas is introduced from the EGR cooler into a longitudinally central portion of the intake manifold, so that it becomes possible to enhance EGR gas distribution performance with respect to cylinders.

In the above exhaust gas recirculation system, EGR gas can be sufficiently cooled before being introduced into the EGR cooler, so that it is possible to suppress an excessive temperature rise of the EGR cooler. Thus, the intake manifold 4 is preferably formed of a resin material.

This feature makes it possible to achieve a reduction in weight and cost of the intake manifold and thus a reduction in weight and cost of the engine.

In a turbocharged engine, an exhaust gas temperature in a high-speed and high-load operation region can reach a high temperature of about 900 to 1000° C. In the case where such high-temperature exhaust gas is recirculated as EGR gas to the intake manifold via only the EGR cooler, the EGR cooler undergoes large heat expansion, thereby possibly causing degradation due thermal fatigue.

Thus, the exhaust gas recirculation system of the present invention is particularly useful in the case where the engine is a turbocharged engine, wherein the exhaust gas recirculation system is operable to recirculate the EGR gas to the intake manifold in a high-speed and high-load operation region of the engine.

This application is based on Japanese Patent application No. 2014-265912 filed in Japan Patent Office on Dec. 26, 2014, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An exhaust gas recirculation system provided in an engine to recirculate, to an intake manifold, a part of exhaust gas discharged from an engine body as EGR gas, comprising:
an in-head gas passage formed in a cylinder head to allow the EGR gas to pass through a position adjacent to a first coolant jacket formed in the cylinder head to allow coolant to flow therethrough;
an EGR cooler configured to cool the EGR gas after passing through the cylinder head via the in-head gas passage and before being introduced into the intake manifold; and
a relay pipe configured to guide the EGR gas just after passing through the cylinder head, to the EGR cooler, wherein the relay pipe is provided with a second coolant jacket for allowing coolant to flow therethrough so as to cool the EGR gas being flowing inside the relay pipe.

2. The exhaust gas recirculation system as recited in claim 1, wherein the relay pipe is connected directly to each of the cylinder head and the EGR cooler.

3. The exhaust gas recirculation system as recited in claim 1, wherein the first coolant jacket of the cylinder head has a portion surrounding the in-head gas passage in an angular range of at least 90 degrees or more in a cross-section thereof.

4. The exhaust gas recirculation system as recited in claim 1, wherein the relay pipe has a pipe body for allowing the EGR gas to flow therethrough, and wherein the second cooling jacket of the relay pipe surrounds the pipe body entirely therearound.

5. The exhaust gas recirculation system as recited in claim 1, wherein the EGR cooler is fixed to an upper portion of the intake manifold in such a manner that a gas inlet of the EGR cooler is located offset upwardly with respect to a gas outlet of the in-head gas passage, and wherein the relay pipe is disposed to extend in an up-down direction to fluidically connect the gas outlet to the gas inlet.

6. The exhaust gas recirculation system as recited in claim 4, wherein the EGR cooler has a shape extending in a cylinder row direction of the engine body, and wherein the exhaust gas recirculation system further comprises a guide passage section for introducing the EGR gas after being cooled by the EGR cooler, to the intake manifold at position of a central portion thereof in the cylinder row direction.

7. The exhaust gas recirculation system as recited in claim 5, wherein the intake manifold is formed of a resin material.

8. The exhaust gas recirculation system as recited in claim 1, wherein the engine is a turbocharged engine, and wherein the exhaust gas recirculation system is operable to recirculate the EGR gas to the intake manifold in a high-speed and high-load operation region of the engine.
